(19) United States
(12) Patent Application Publication
(10) Pub. No.: US 2012/0039496 A1
(43) Pub. Date: Feb. 16, 2012

(54) METHOD FOR REDUCING INTERFERENCE AND HEARING DEVICE

(75) Inventors: DANIEL BERTKO, Hong Kong (HK); PETER NIKLES, ERLANGEN (DE)

(73) Assignee: SIEMENS MEDICAL INSTRUMENTS PTE. LTD., SINGAPORE (SG)

(21) Appl. No.: 13/209,772

(22) Filed: Aug. 15, 2011

(30) Foreign Application Priority Data
Aug. 13, 2010 (DE) 10 2010 039 303.7

(51) Int. Cl. H04R 25/00

(52) U.S. Cl. 381/316

(57) ABSTRACT

A method for operating a hearing device, which is embodied for wireless signal transmission of a data signal at a transmission frequency, provides an audio signal as a pulsed signal, in which a plurality of pulses fall within a predefined time slot. A frequency spectrum of the audio signal has a notch into which the transmission frequency is placed, and the pulses of the audio signal within the predefined time slot are shifted such that the energy of the frequency spectrum drops in the vicinity of the transmission frequency.

### CROSS-REFERENCE TO RELATED APPLICATION

This application claims the priority, under 35 U.S.C. §119, of German application DE 10 2010 039 303.7, filed Aug. 13, 2010; the prior application is herewith incorporated by reference in its entirety.

### BACKGROUND OF THE INVENTION

### Field of the Invention

The invention relates to a method for operating a hearing device, which is embodied for wireless signal transmission of a data signal at a transmission frequency, by providing an audio signal as a pulsed signal, in which a plurality of pulses fall within a predefined time slot, wherein the frequency spectrum of the audio signal has a notch into which the transmission frequency is placed. Moreover, the invention relates to a corresponding hearing device with a transmission apparatus for wireless signal transmission and a signal processing apparatus for processing pulsed signals. Here, a hearing device is understood to mean any sound-emitting equipment that can be worn in or on the ear, more particularly a hearing aid, a headset, earphones, or the like.

Hearing aids are portable hearing devices used to support the hard of hearing. In order to make concessions for the numerous individual requirements, different types of hearing aids are provided, e.g. behind-the-ear (BTE) hearing aids, hearing aids with an external receiver (receiver in the canal [RIC]) and in-the-ear (ITE) hearing aids, for example concha hearing aids or canal hearing aids (ITE, CIC) as well. The hearing aids listed in an exemplary fashion are worn on the concha or in the auditory canal. Furthermore, bone conduction hearing aids, implantable or vibrotactile hearing aids are also commercially available. In this case, the damaged sense of hearing is stimulated either mechanically or electrically.

In principle, the main components of hearing aids are an input transducer, an amplifier and an output transducer. In general, the input transducer is a sound receiver, e.g. a microphone, and/or an electromagnetic receiver, e.g. an induction coil. The output transducer is usually configured as an electroacoustic transducer, e.g. a miniaturized loudspeaker, or as an electromechanical transducer, e.g. a bone conduction receiver. The amplifier is usually integrated into a signal processing unit. This basic design is illustrated in FIG. 1 using the example of a behind-the-ear hearing aid. One or more microphones 2 for recording the sound from the surroundings are installed in a hearing-aid housing 1 to be worn behind the ear. A signal processing unit 3, likewise integrated into the hearing-aid housing 1, processes the microphone signals and amplifies them. The output signal of the signal processing unit 3 is transferred to a loudspeaker or receiver 4, which emits an acoustic signal. If necessary, the sound is transferred to the eardrum of the equipment wearer using a sound tube, which is fixed in the auditory canal with an ear mold. A battery 5, likewise integrated into the hearing-aid housing 1, supplies the hearing aid and, in particular, the signal processing unit 3 with energy.

In digital hearing aids, the input signals to the receiver are digitally converted and often subjected to pulse density modulation. Alternatively, the audio signals to be processed can for example also be subjected to pulse width modulation or pulse code modulation. However, the examples in the following text always relate to pulse density modulation (PDM).

Modern, digital hearing aids often also contain a wireless communication system, by which data can be interchanged wirelessly with external equipment. The data transmission of these communication systems typically takes place within a narrow frequency band in the megahertz range. Compared to this, a pulse-density-modulated audio signal has a very broad spectrum. At the points of maximum pulse frequency in the audio signal, the spectrum has the typical notches.

As a result of the broad spectrum resulting from the pulse density modulation of the audio signal there is interference with the transmission frequency of the wireless communication system of the hearing aid. This means that, from the point of view of the transmission system, the PDM signal occurs as disturbance and hence has a detrimental effect on the signal-to-noise ratio (SNR). In end effect this leads to a higher symbol error rate.

Until now, the center frequency of the wireless transmission system was placed into a notch of the spectrum (zero in the amplitude spectrum) of the audio signal. Such notches in the spectrum of the audio signal are found at all multiples of the maximum pulse frequency of the pulse-density-modulated audio signal. In these regions the spectral energy of the PDM signal is very low within a narrow band range. Firstly, such a notch is very narrow and secondly images of the baseband audio signal occur in each notch. In order to keep the interference between the pulse-density-modulated audio signal and the high-frequency data signal of the wireless transmission system as low as possible, use is often made of electromagnetic shielding.

A traditional approach to reducing the signal power at relatively high frequencies consists of using an analog low-pass filter (LPF); however, this is absolutely inappropriate in hearing-aid technology. Due to the frequency of the wireless transmission system, which is in the low megahertz range, the reactive elements, by which the required time constants can be achieved, would not only be relatively large-volume but also very expensive. Moreover, the use of a low-pass filter would also reduce the efficiency of the entire apparatus, which in end effect leads to a reduced battery life. Moreover, the output impedance of the driver increases and becomes more frequency dependent.

### SUMMARY OF THE INVENTION

It is accordingly an object of the invention to provide a method for reducing interference and a hearing device which overcome the above-mentioned disadvantages of the prior art methods and devices of this general type, which increases the signal-to-noise ratio in a hearing device from the point of view of the wireless transmission system.

According to the invention, the object is achieved by a method for operating a hearing device, which is embodied for wireless signal transmission of a data signal at a transmission frequency. The method includes the steps of providing an audio signal as a pulsed signal, in which a plurality of pulses fall within a predefined time slot. A frequency spectrum of the audio signal has a notch into which the transmission frequency is placed, and the pulses of the audio signal within the predefined time slot are shifted such that the energy of the frequency spectrum drops in the vicinity of the transmission frequency.

Moreover, according to the invention provision is made for a hearing device with a transmission apparatus for wireless signal transmission of a data signal at a transmission frequency. The hearing device has a signal processing apparatus for providing an audio signal as a pulsed signal, in which a plurality of pulses fall within a predefined time slot. A frequency spectrum of the audio signal has a notch into which the transmission frequency is placed, and the signal processing apparatus can be used to shift the pulses of the audio signal within the predefined time slot such that the energy of the frequency spectrum is reduced in the vicinity of the transmission frequency compared to the un-shifted state. The transmission typically takes place within a frequency band that is usually arranged around a predefined carrier frequency or transmission frequency.

The reorganization of the pulses within a time slot advantageously influences the spectrum of the audio signal (the input signal of the receiver). Now, the pulses can be shifted such that the spectral energy of the audio signal reduces further in the vicinity of the notches, and so, in end effect, there are fewer disturbances by the pulsed audio signal from the point of view of the wireless transmission system and hence the signal-to-noise ratio is improved.

The audio signal is preferably provided as a pulse-density-modulated signal. However, additionally it can also be provided as, for example, a pulse-width-modulated signal or a pulse-code-modulated signal, or the like. In any case the audio signal then has corresponding pulses, which can be reorganized within a specific time slot.

In one advantageous embodiment, at least some of the pulses in the predefined time slot are contiguously shifted together to form a block. As a result of this shifting together there are peaks in the spectrum with increased energy outside of the notches, and so the signal energy drops in the vicinity of the notches.

In particular, at least some of the pulses in the predefined time slot can be shifted to an edge of the time slot. By way of example, the pulses can be shifted to the left edge of the time slot, i.e. at the beginning of the time slot, by simple measures.

Moreover, it is expedient if the predefined time slot has between three and ten pulses, preferably four or five pulses. This can “pull” the energy in the spectrum sufficiently far away from a notch.

As already indicated above, the present invention can be used particularly advantageously in digital equipment that has a wireless communication apparatus.

Other features which are considered as characteristic for the invention are set forth in the appended claims.

Although the invention is illustrated and described herein as embodied in a method for reducing interference and a hearing device, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic illustration of a hearing aid according to the prior art;

FIG. 2 is a graph showing a pulse-density-modulated signal;

FIG. 3 is a graph showing a pulse-density-modulated signal after a reorganization according to the invention;

FIG. 4 is a graph showing a frequency spectra of the audio signals from FIG. 2 and FIG. 3;

FIG. 5 is a graph showing a difference spectrum of the spectra illustrated in FIG. 4; and

FIG. 6 is a graph showing the spectrum of the reorganized signal in the baseband region (audible region).

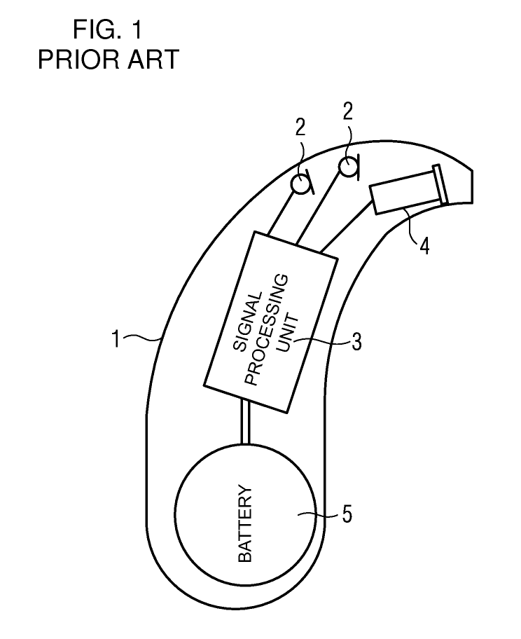

### DETAILED DESCRIPTION OF THE INVENTION

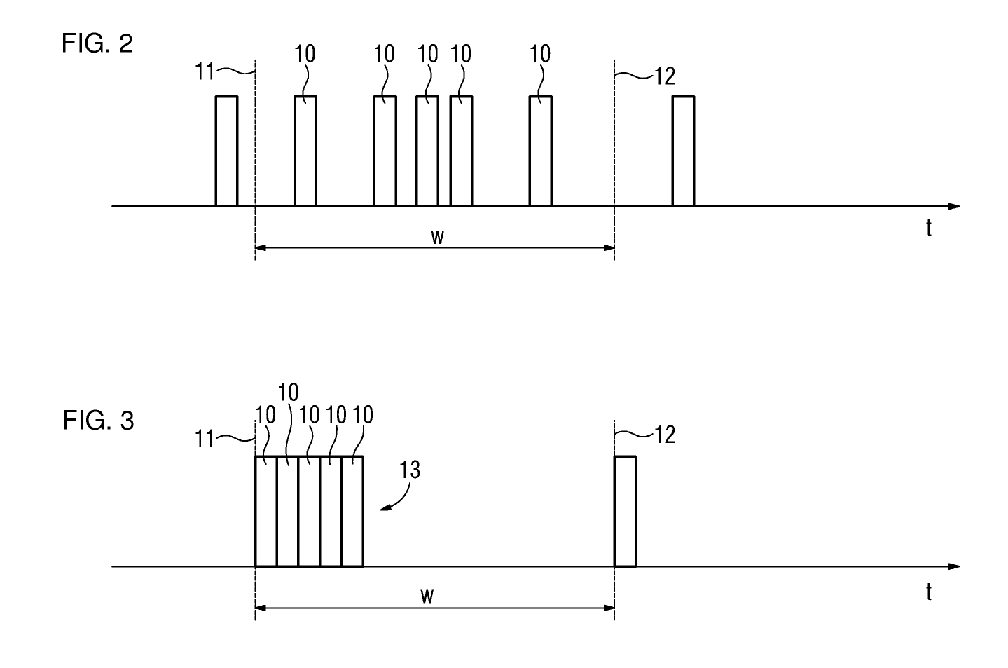

The audio signal to be processed is modulated in a hearing aid or another hearing device with the aid of e.g. pulse width modulation. FIG. 2 shows such a pulse-width-modulated signal. Here, there are five individual pulses in a time slot of a predetermined duration w. The slot has a left edge 11 and a right edge 12. In accordance with the present invention, the PDM current is modified in the time domain. Therefore the individual pulses 10 within a slot of duration w are reorganized in order to deform the spectrum of the PDM signal.

In the example in FIG. 3, the pulses are reorganized such that they are all shifted within the slot to the left edge 11. Thus, all five pulses 10 are shifted together to form a block, and this block starts at the left edge 11 of the slot with the duration w. However, the block 13 can, for example, also be shifted to the right edge 12 of the slot. Furthermore, the block 13 can also be arranged at any other point within the slot. By way of example, all pulses can be arranged to form a block directly adjoining the first pulse on the right-hand side. Even though FIG. 3 illustrates a contiguous block 13 made of five pulses, a small spacing may remain between the individual pulses in an alternative embodiment. Likewise, it is not mandatory that all pulses within the slot are reorganized. Rather, within the scope of the invention it is sufficient for at least a few of the pulses to be shifted within the slot.

If all pulses are now shifted to e.g. the left edge of a slot, and if there is a substantially uniform distribution (“pulse” (HIGH) on average occur as often as “no pulse” (LOW)), i.e. p(HIGH)=p(LOW)=0.5, the resultant, modified signal has rectangular properties. In the frequency domain, the modified PDM signal 14 leads to discrete lines 15 with the spacing of f r=f_A/w, which represents the rectangle with the shifted together pulses in the time domain. Here, f_A represents the maximum pulse frequency.

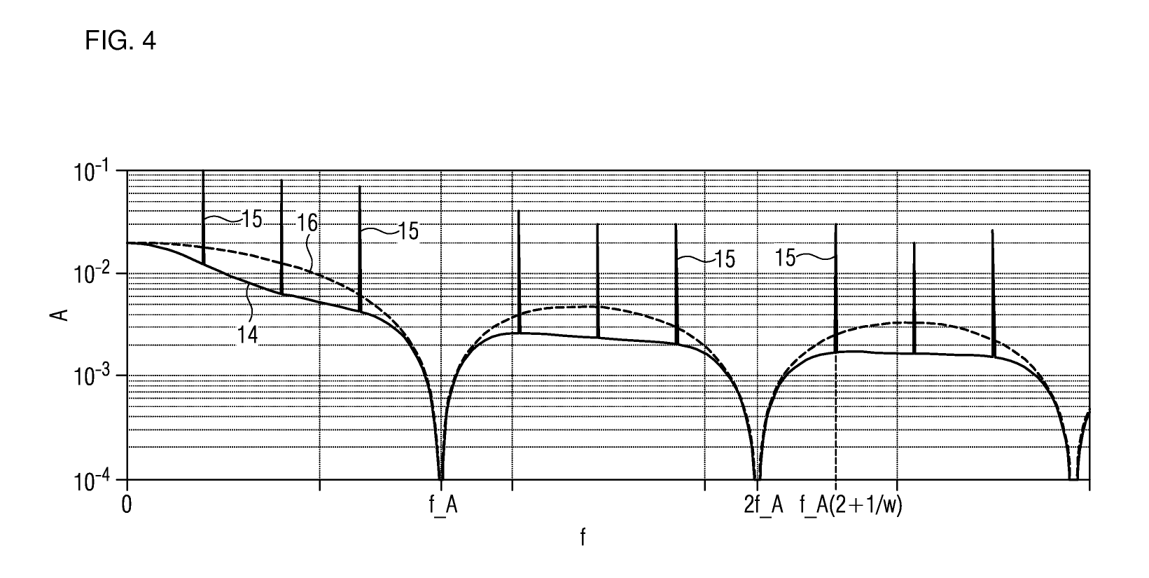

FIG. 4 also illustrates the spectrum 16 of the unmodified PDM signal as per FIG. 2. The communication system in the hearing device for wireless communication operates at the frequency 2f_A, i.e. in the second notch 17 of the spectrum 16 in the example of FIG. 4.

In the present example, the duration w of the slot is set to the variable 4, which means that there are w−1=3 equidistantly spaced lines 15 between two notches 17. The first discrete line next to the frequency or frequency band 2f_A of the wireless transmission system is at f_A (2+1/w).

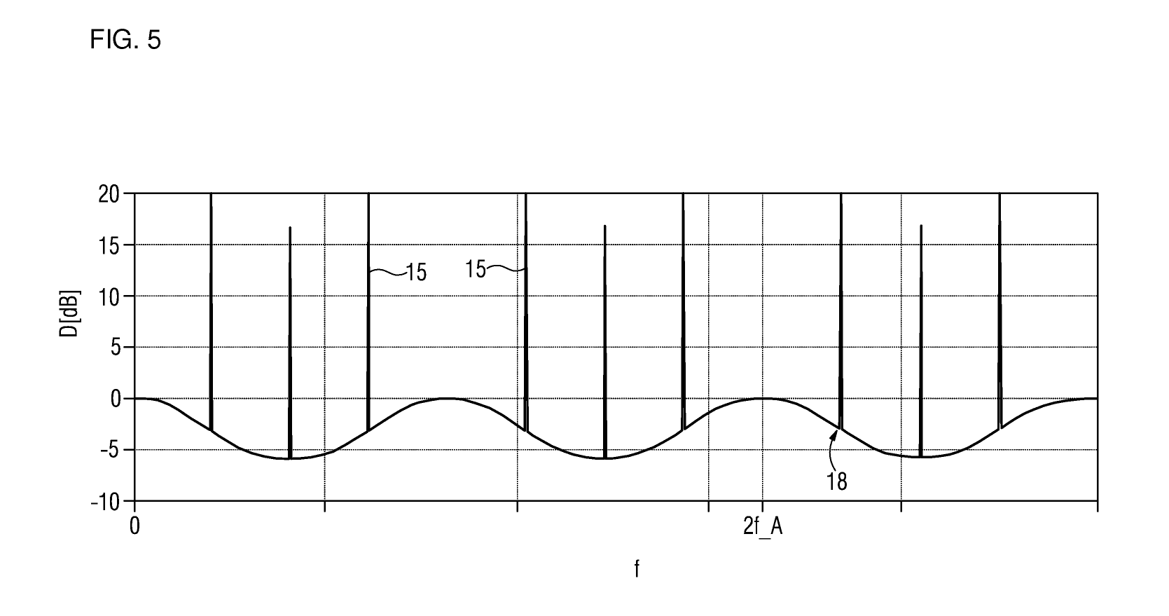

As a result of the fact that the power is the same in both the unmodified signal and the modified signal, the concentration of the power in discrete lines 15 necessarily results in a reduction of power around these. Up to the first discrete line 15 at f_A (2+−1/w), the power of the modified signal is reduced by half (−3 dB) compared to the unmodified signal. This can be gathered even more clearly from FIG. 5, which illustrates the difference between the two spectra 14 and 16. Thus, this difference spectrum shows the damping D of the modified signal with respect to the unmodified signal. The modified signal only has a higher power than the unmodified signal in the vicinity of the discrete line 15. Moreover, it can be gathered from FIG. 5 that the signal power of the PDM audio signal is reduced to the left and right of the transmission frequency 2f_A of the wireless transmission system as a result of the modification. By way of example, at the point 18, i.e. just before the discrete line at f_A (2+1/w), the drop in power is 3 dB, as mentioned above. For the wireless transmission system, this means that there is less interference power in the vicinity of the transmission frequency or transmission frequency band. Thus, the modification advantageously adapted the noise spectrum.

Increasing the SNR for wireless communication by reducing the power of the PDM signal around the discrete lines offers the chance of increasing the packing density of a hearing device or a hearing aid. As a result of the improved electromagnetic compatibility of the wireless transmission system with the internal signal processing equipment of the hearing device, the audio and RF components can be arranged closer together in the layout. Moreover, costs can be saved to the effect that expensive shielding can be dispensed with.

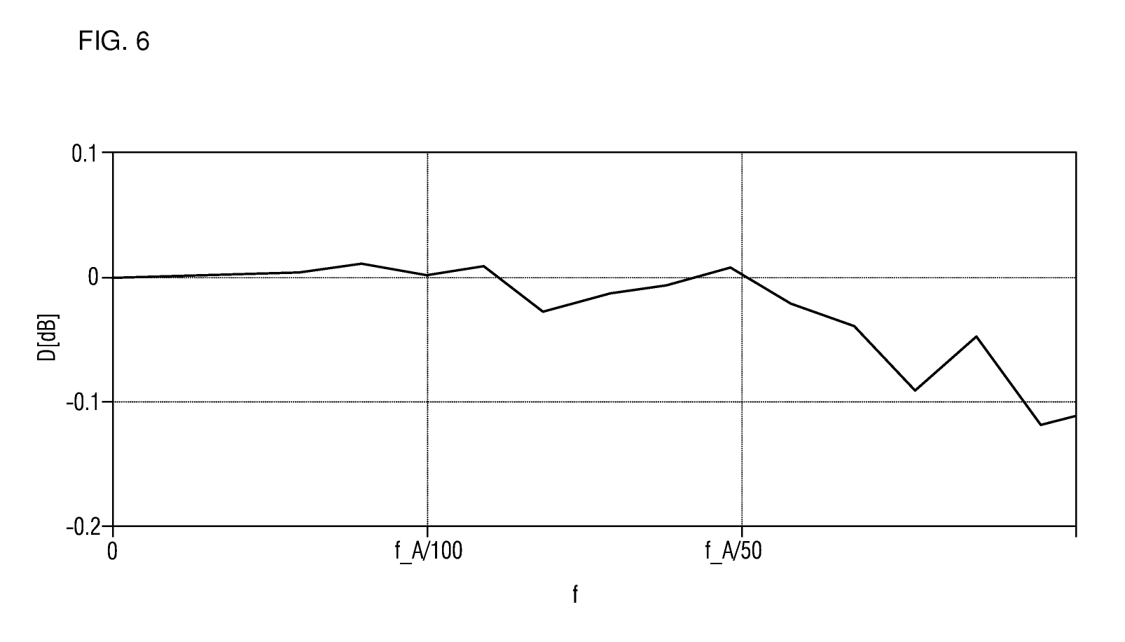

Now, the only question that remains unanswered is whether the modification of the PDM or audio signal changes the hearing impression of a user of the hearing device. This can be answered in the negative using the illustration in FIG. 6. This figure represents an enlarged section of FIG. 5. It illustrates the damping D at very low frequencies in order to be able to identify to what extent the baseband of the audio signal is influenced by the modification. In the selected example, the PDM frequency is at f_A=1.63 MHz. This means that f_A/50=32.8 kHz. It can be identified from FIG. 6 that the frequency range up to f_A/50 is practically unaffected by the modification. The damping is approximately constant at 0 dB. However, this range is more than sufficient for processing an audio signal. Hence the hearing impression will not change for the user as a result of the modification.

1. A method for operating a hearing device embodied for wireless signal transmission of a data signal at a transmission frequency, which comprises the steps of:
providing an audio signal as a pulsed signal, in which a plurality of pulses fall within a predefined time slot, wherein a frequency spectrum of the audio signal has a notch into which a transmission frequency is placed; and
shifting the pulses of the audio signal within the predefined time slot such that energy of the frequency spectrum drops in a vicinity of the transmission frequency.

2. The method according to claim 1, which further comprises forming the audio signal as a pulse-density-modulated signal.

3. The method according to claim 2, which further comprises forming the audio signal as a pulse-width-modulated signal.

4. The method according to claim 1, wherein at least some of the pulses in the predefined time slot are contiguously shifted together to form a block.

5. The method according to claim 1, wherein at least some of the pulses in the predefined time slot are contiguously shifted to an edge of the predefined time slot.

6. The method according to claim 1, wherein between three and ten pulses fall within the predefined time slot.

7. The method according to claim 1, wherein four to five pulses fall within the predefined time slot.

8. A hearing device, comprising:
a transmission apparatus for wireless signal transmission of a data signal at a transmission frequency; and
a signal processing apparatus for providing an audio signal as a pulsed signal, the audio signal having a plurality of pulses falling within a predefined time slot and a frequency spectrum of the audio signal has a notch into which the transmission frequency is placed, said signal processing apparatus can be used to shift the pulses of the audio signal within the predefined time slot such that energy of the frequency spectrum is reduced in a vicinity of the transmission frequency compared to an un-shifted state.

9. The hearing device according to claim 8, wherein said signal processing apparatus has a modulation unit by which the audio signal can be pulse-density modulated or pulse-width modulated.

10. The hearing device according to claim 8, wherein said signal processing apparatus can be used to shift at least some of the pulses within the predefined time slot contiguously to form a block.

11. The hearing device according to claim 8, wherein the hearing device is a hearing aid.

12. The hearing device according to claim 8, wherein said signal processing apparatus shifts at least some of the pulses within the predefined time slot contiguously to an edge of the predefined time slot.

13. The hearing device according to claim 8, wherein said signal processing apparatus shifts at least some of the pulses within the predefined time slot contiguously to form a block at an edge of the predefined time slot.
